(19) United States
(12) Patent Application Publication
(10) Pub. No.: US 2011/0013231 A1
(43) Pub. Date: Jan. 20, 2011

(54) IMAGE READING APPARATUS, IMAGE PROCESSOR AND COLOR DETERMINATION METHOD

(75) Inventor: Kazuko HAGIO, Ebina-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/796,402

(22) Filed: Jun. 8, 2010

(30) Foreign Application Priority Data
Jul. 16, 2009 (JP) 2009-168300

(51) Int. Cl. H04N 1/40; H04N 1/04

(52) U.S. Cl. 358/443; 358/474

(57) ABSTRACT

An image reading apparatus includes: a light source that irradiates a document sheet with light; a light receiving unit that receives reflected light from the document sheet; and a color determination unit that performs color determination as to whether an image of the document sheet is any one of a monochrome image and a color image. The color determination unit performs the color determination as to whether the image of the document sheet is any one of a monochrome image and a color image by comparing chroma information of the image of the document sheet read by the light receiving unit with a threshold calculated from chroma information obtained by reading an image having a predetermined chroma.

### CROSS REFERENCE TO RELATED APPLICATIONS

This application is based on and claims priority under 35 USC §119 from Japanese Patent Application No. 2009-168300 filed Jul. 16, 2009.

### BACKGROUND

1. Technical Field

The present invention relates to an image reading apparatus, an image processor and a color determination method.

2. Related Art

An image reading apparatus that automatically reads image information of a document sheet has been used as a scanner or the like for input to a copy machine, a facsimile and a computer. Such an image reading apparatus causes light sources extending in a direction orthogonal to a transport path of a document sheet to irradiate the document sheet with light, causes an image sensor to receive reflected light from the document sheet irradiated with the light, and thereby reads an image on the document sheet.

### SUMMARY

According to an aspect of the present invention, there is provided an image reading apparatus including: a light source that irradiates a document sheet with light; a light receiving unit that receives reflected light from the document sheet; and a color determination unit that performs color determination as to whether an image of the document sheet is a monochrome image or a color image. The color determination unit performs the color determination as to whether the image of the document sheet is a monochrome image or a color image by comparing chroma information of the image of the document sheet read by the light receiving unit with a threshold calculated from chroma information obtained by reading an image having a predetermined chroma.

### BRIEF DESCRIPTION OF THE DRAWINGS

Exemplary embodiment(s) of the present invention will be described in detail based on the following figures, wherein:

FIG. 1 is a diagram showing a configuration example of an image reading apparatus according to the exemplary embodiment;

FIG. 2 is a block diagram for explaining the control/image-processing unit;

FIG. 3 is a block diagram for explaining the pre-processor;

FIG. 4 is a block diagram for explaining the ACS processor;

FIGS. 5A and 5B are graphs respectively showing a relationship between an a* value and an L* value and a relationship between a b* value and an L* value on a pixel-by-pixel basis when a monochrome image is actually read by the image reading apparatus;

FIG. 6 is a flowchart illustrating a first procedure of the color determination according to the exemplary embodiment;

FIG. 7 is a flowchart illustrating a second procedure of the color determination according to the exemplary embodiment; and

FIG. 8 is a flowchart illustrating a third procedure of the color determination according to the exemplary embodiment.

### DETAILED DESCRIPTION

### <Description of Whole Image Reading Apparatus>

Hereinafter, a description will be given of an exemplary embodiment of the present invention in detail with reference to the attached drawings.

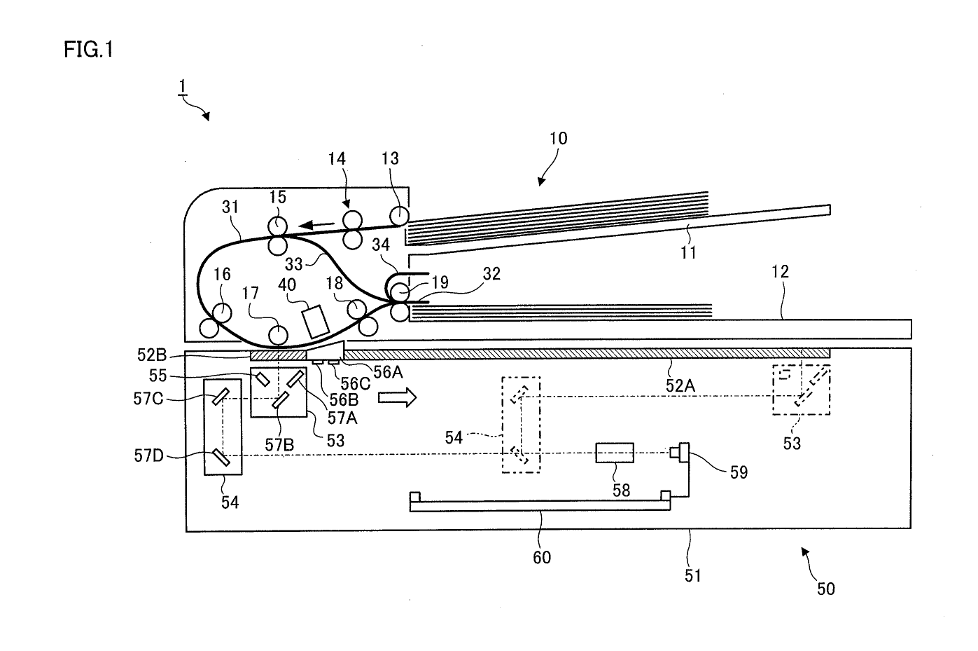

FIG. 1 is a diagram showing a configuration example of an image reading apparatus according to the present exemplary embodiment. The image reading apparatus 1 shown in FIG. 1 is capable of reading an image on a document sheet being transported as well as an image on a fixed document sheet. The image reading apparatus 1 includes: a document feeder 10 that sequentially transports a document sheet from a stacked bundle of document sheets; and a reading device 50 that reads an image by scanning.

The document feeder 10 includes: a document stacking part 11 that stacks thereon a bundle of document sheets composed of plural document sheets; and an exit paper stacking part 12 that is provided below the document stacking part 11 and stacks the document sheets having been read. In addition, the document feeder 10 includes a transport roll 13 that takes out and transports the document sheets in the document stacking part 11. Further, on the downstream side of the transport roll 13 in the document transport direction, a separating mechanism 14 that separates sheets one by one by a feed roll and a retard roll is provided. In a first transport path 31 on which the document sheets are transported, pre-registration rolls 15, registration rolls 16, a platen roll 17 and out rolls 18 are provided in order from the upstream side in the document transport direction. Moreover, inside the document feeder 10, a contact image sensor (CIS) unit 40 is provided.

The pre-registration rolls 15 transport a document sheet separated one by one toward rolls on the downstream side thereof while forming a loop of the document sheet. The registration rolls 16 restart rotation in conjunction with the read start timing after a temporary halt to feed the document sheet while performing adjustment of registration (displacement) on the reading device 50 to be described later. The platen roll 17 assists transportation of the document sheet being read by the reading device 50. The out rolls 18 transport the document sheet read by the reading device 50 further downstream. In addition, on the downstream side of the out rolls 18 in the document transport direction, a second transport path 32 that guides the document sheets to the exit paper stacking part 12 is provided. In the second transport path 32, exit rolls 19 are provided.

Furthermore, in the image reading apparatus 1, a third transport path 33 is provided between an outlet side of the out rolls 18 and an inlet side of the pre-registration rolls 15 so that an image formed on both faces of the document sheet may be read in one process. The above-mentioned exit rolls 19 have a function to reverse and transport the document sheet to the third transport path 33.

Still furthermore, in the image reading apparatus 1, a fourth transport path 34 is provided for reversing the document sheet again and discharging the document sheet to the exit paper stacking part 12 at discharge if the both faces of the document sheet are read. The fourth transport path 34 is provided on an upper side of the second transport path 32. The above-mentioned exit rolls 19 further has a function to reverse and transport the document sheet to the fourth transport path 34.

On the other hand, the reading device 50 supports the above-mentioned document feeder 10 openably and closably, and supports the document feeder 10 with a device frame 51, and further reads an image of a document sheet transported by the document feeder 10. The reading device 50 includes: the device frame 51 constituting a housing; a first platen glass 52A on which a document sheet having an image to be read is placed in a stationary state; and a second platen glass 52B having an opening portion for light used to read a document sheet transported by the document feeder 10. The second platen glass 52B is made of a transparent glass plate in the form of a long plate, for example.

In addition, the reading device 50 includes: a full-rate carriage 53 that reads an image by staying still under the second platen glass 52B or by scanning across the entire first platen glass 52A; and a half-rate carriage 54 that supplies light obtained from the full-rate carriage 53 to an image forming part. The full-rate carriage 53 is provided with a light source 55 that irradiates a document sheet with light, a first mirror 57A that reflects the light from the light source 55 to irradiate the document sheet, and a second mirror 57B that reflects reflected light obtained from the document sheet. Furthermore, the half-rate carriage 54 is provided with a third mirror 57C and a fourth mirror 57D that provides light obtained from the second mirror 57B to the image forming part. Additionally, the reading device 50 includes a driving source (not shown in the figure), such as a motor, that moves the half-rate carriage 54 and the full-rate carriage 53 including the light source 55 in a second scan direction. This driving source functions as a scan unit.

The reading device 50 further includes an image forming lens 58 and a CCD image sensor 59, which is an example of a light receiving unit that receives reflected light from the document sheet and is an example of a reading unit that reads an image of a document sheet. Among them, the image forming lens 58 optically reduces an optical image obtained from the fourth mirror 57D. Meanwhile, the CCD image sensor 59 photoelectrically converts an optical image formed by the image forming lens 58. That is, in the reading device 50, an image is formed on the CCD image sensor 59 by using a so-called minification optical system. The CCD image sensor 59 is formed of a three-line color CCD sensor or the like, for example. The CCD image sensor 59 photoelectrically converts the reflected light from the document sheet on a pixel-by-pixel basis, and outputs analogue image signals of R (red), G (green) and B (blue) (hereinafter, referred to as “RGB signals”). Moreover, in the reading device 50, a guide 56A that guides a document sheet transported in the document feeder 10 is formed between the first platen glass 52A and the second platen glass 52B. On the bottom of the guide 56A, a white reference plate 56B and a chroma reference plate 56C, as an example of a chroma reference member, that extend along a first scan direction are attached.

In addition, the reading device 50 further includes a control/image-processing unit 60 as an example of a controller. The control/image-processing unit 60 performs predetermined processing on image data of the document sheet inputted from an image sensor (not shown in the figure) provided for the contact image sensor unit 40 and from the CCD image sensor 59. Moreover, the control/image-processing unit 60 controls operations of each unit in a reading operation of the image reading apparatus 1 (the document feeder 10, the reading device 50 and the contact image sensor unit 40).

Next, a description will be given of image reading by the image reading apparatus 1. For example, when an image on a document sheet placed on the first platen glass 52A is read, the full-rate carriage 53 and the half-rate carriage 54 move in a scan direction (a direction indicated by an arrow in FIG. 1) at a ratio of 2:1. At this time, light is emitted from the light source 55 in the full-rate carriage 53 through the first mirror 57A to a reading target surface of the document sheet. Then, the reflected light from the document sheet is reflected at the second mirror 57B.

After that, the reflected light is reflected by the third mirror 57C and the fourth mirror 57D in this order and is guided to the image forming lens 58. The light guided to the image forming lens 58 then forms an image on a light receiving face of the CCD image sensor 59. The CCD image sensor 59 is a one-dimensional sensor and processes one line at a time. When reading of one line in the line direction (first scan direction of the scan) is finished, the full-rate carriage 53 is moved in a direction (the second scan direction) orthogonal to the first scan direction so as to read the subsequent line of the document sheet. By repeating the above process over the entire document sheet size, document reading over one page is completed.

On the other hand, when an image on a document sheet transported by the document feeder 10 is read, the document sheet transported by the document feeder 10 passes over the second platen glass 52B. At this time, the full-rate carriage 53 and the half-rate carriage 54 are in a stopped state at a solid-line position shown in FIG. 1. The reflected light from the first line of the document sheet having passed through the platen roll 17 of the document feeder 10 is guided through the second mirror 57B, the third mirror 57C, and the fourth mirror 57D to the image forming lens 58.

Then, the reflected light forms an image at the image forming lens 58, and the image is read by the CCD image sensor 59. After image data corresponding to one line in the first scan direction is processed at a time by the CCD image sensor 59, which is a one-dimensional sensor, one subsequent line in the first scan direction of the document sheet being transported by the document feeder 10 is read. After that, by passage of a trailing end of the document sheet over a reading position of the second platen glass 52B, reading over one page in the second scan direction is completed. Here, in the present exemplary embodiment, when a first face of the document sheet is read by the CCD image sensor 59, a second face of the document sheet may also be read by the contact image sensor unit 40 at the same time.

### <Description of Control/Image-Processing Unit>

Next, a description will be given of the control/image-processing unit 60 shown in FIG. 1.

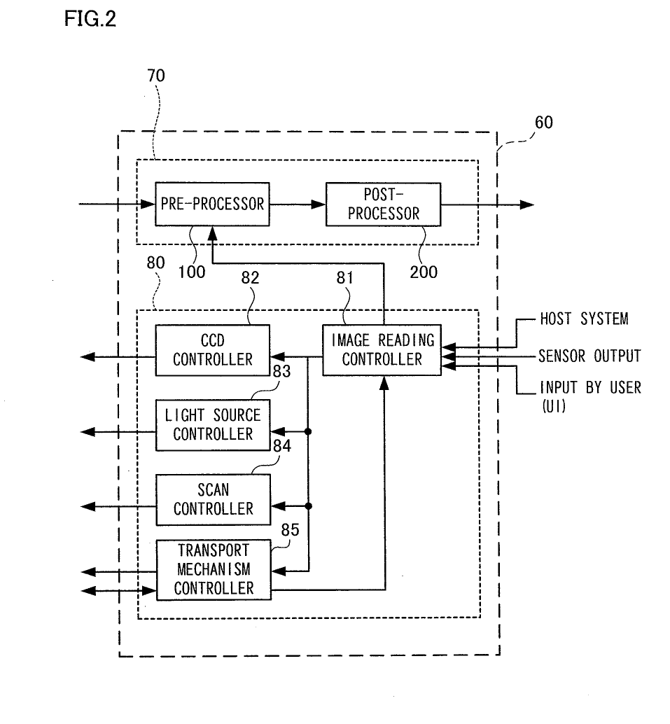

FIG. 2 is a block diagram for explaining the control/image-processing unit 60. The control/image-processing unit 60 to which the present exemplary embodiment is applied generally includes: a signal processor 70 that performs processing on image information obtained from the CCD image sensor 59; and a device controller 80 that controls the document feeder 10 and the reading device 50. The signal processor 70 performs predetermined image processing on the output from the CCD image sensor 59. The signal processor 70 includes: a pre-processor 100 that performs processing, such as an analog-to-digital conversion (A/D conversion), on inputted analog image signals; and a post-processor 200 that performs scaling, contrast adjustment, ground color removal, binarization and the like on digital image signals subjected to the image processing by the pre-processor 100. The output from the signal processor 70 is further outputted to an image output terminal (IOT) such as a printer, or a host system such as a personal computer (PC), for example.

On the other hand, the device controller 80 includes an image reading controller 81, a CCD controller 82, a light source controller 83, a scan controller 84 and a transport mechanism controller 85. The image reading controller 81 performs overall control of the document feeder 10 and the reading device 50 as well as control of one-side reading and double-side reading. The CCD controller 82 controls the CCD image sensor 59. The light source controller 83 controls the light source 55 according to reading timing. The scan controller 84 turns on and off a motor in the reading device 50 to control scan operations of the full-rate carriage 53 and the half-rate carriage 54. The transport mechanism controller 85 controls a motor in the document feeder 10, and also controls: operations of the various rolls and of a feed clutch; gate switching operations; and the like. Control signals are outputted from these various controllers to the document feeder 10 and the reading device 50. Operation control of the document feeder 10 and the reading device 50 is achieved on the basis of these control signals.

The image reading controller 81 sets a reading mode and controls the document feeder 10 and the reading device 50, on the basis of a control signal from the host system, sensor output detected by an automatically-selected reading function, for example, and selection or the like from a user through a user interface (UI). As such a reading mode, the following mode are conceivable: a fixed-document reading mode in which a document sheet placed on the first platen glass 52A is to be read; and a transported-document reading mode including a one-side reading mode in which reading is performed by a single pass and a reverse double-side reading mode in which reading is performed by a reversal pass. In addition, for example, the following modes are settable: a character-image reading mode (character mode) in which image data with sufficient legibility of a character image is outputted by performing predetermined processing on the image data obtained by reading a document sheet; a photography-image reading mode (photography mode) in which image data with sufficient legibility of a photography image is outputted by performing predetermined processing on the image data obtained by reading a document sheet. The information on an image reading mode, such as the character mode and the photography mode, designated by the user is outputted to the pre-processor 100 provided for the signal processor 70.

### <Description of Pre-Processor>

Next, a detailed description will be given of the pre-processor 100.

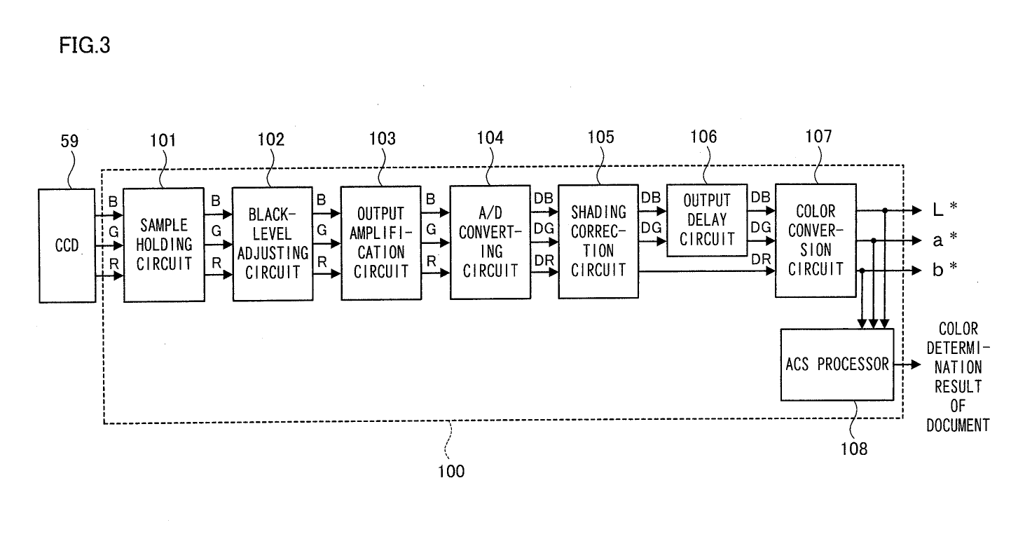

FIG. 3 is a block diagram for explaining the pre-processor 100.

The pre-processor 100 shown in FIG. 3 includes a sample holding circuit 101, a black-level adjusting circuit 102, an output amplification circuit 103, an A/D converting circuit 104, a shading correction circuit 105, an output delay circuit 106, a color conversion circuit 107 and an auto color selection (ACS) processor 108, which is an example of a color determination unit.

The sample holding circuit 101 receives RGB signals as analog image data from the CCD image sensor 59, performs sampling and holds the signals for a predetermined time period. The RGB signals are amplified up to a predetermined output level by the output amplification circuit 103 after the adjustment of a brightness level of black by the black-level adjusting circuit 102.

Next, the RGB signals, which are analog signals, are subjected to the A/D conversion by the A/D converting circuit 104 for each pixel of the CCD image sensor 59, and thereby become DR, DG and DB signals as digital image data. A density of the digital image data after the A/D conversion is expressed with 8 bits (256 scales), for example, and thus the minimum 0 is outputted for black while the maximum 255 is outputted for white. The DR, DG and DB signals are corrected by the shading correction circuit 105 so as to change uneven brightness of an image due to the characteristics of the image forming lens 58 and the CCD image sensor 59 (see FIG. 1) into uniform brightness. Then, gap correction is performed on the DG and DB signals by the output delay circuit 106 so that the DR, DG and DB signals correspond to signals obtained by reading at the same time and location. Furthermore, the DR, DG and DB signals are converted into L*, a* and b* signals, which are color signals in an L*a*b* colorimetric system, by the color conversion circuit 107.

The L*, a* and b* signals are transmitted to the post-processor 200 in FIG. 2, and inputted into the ACS processor 108. Then, the ACS processor 108 performs discrimination (ACS processing) as to whether an image of a document sheet to be read is a monochrome image or a color image.

### <Description of ACS Processor>

Next, a detailed description will be given of the ACS processor 108.

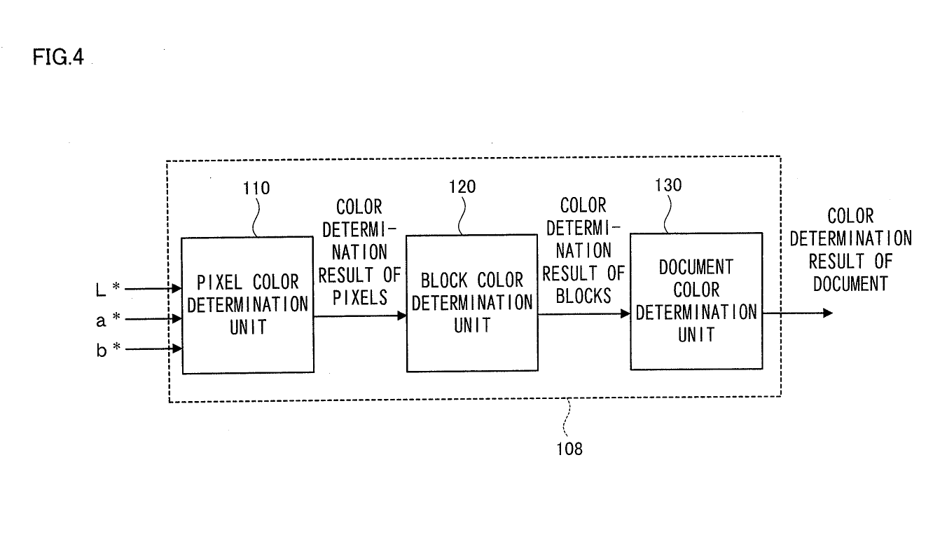

FIG. 4 is a block diagram for explaining the ACS processor 108. As shown in FIG. 4, the ACS processor 108 includes a pixel color determination unit 110, a block color determination unit 120 and a document color determination unit 130. The pixel color determination unit 110 determines whether a pixel forming a document image read by the reading device 50 is a monochrome pixel or a color pixel.

The determination of pixel color (a color pixel or a monochrome pixel) in the pixel color determination unit 110 is performed for each pixel forming the read image of the document sheet (performed on a pixel-by-pixel basis). Specifically, the determination of pixel color is performed based on the a* and b* signals, which are chroma information, among the above-mentioned L*, a* and b* signals. More specifically, maximum and minimum thresholds are set for each of the a* and b* signals, and each of the a* and b* signals is compared with the corresponding maximum and minimum thresholds. Then, whether a pixel being a determination target is a monochrome pixel or a color pixel is determined on the basis of this comparison result. The result of the color determination for each of the pixels by the pixel color determination unit 110 is transmitted to the block color determination unit 120.

The block color determination unit 120 determines whether a block is a monochrome block or a color block for each of blocks. The blocks here are obtained by dividing a read region of an image corresponding to a document sheet size into units of M lines times N pixels set in advance. The determination results of pixel color transmitted from the pixel color determination unit 110 are used for determination processing of block color (monochrome or color) in the block color determination unit 120. Specifically, the block color determination unit 120 counts the number of color pixels included in a block divided as described above, and compares the counted value with maximum and minimum thresholds set in advance for the block color determination. Then, whether a block being a determination target is a monochrome block or a color block is determined on the basis of this comparison result. The result of the color determination for each of the blocks by the block color determination unit 120 is transmitted to the document color determination unit 130.

The document color determination unit 130 determines whether a document of which an image is read is a monochrome document or a color document. The determination results of block color transmitted from the block color determination unit 120 are used for determination processing of document color (monochrome or color) in the document color determination unit 130. Specifically, the document color determination unit 130 counts the number of blocks having been determined to be color by the block color determination unit 120 among the blocks divided in the read region of the image corresponding to the document sheet size as described above. The document color determination unit 130 compares the counted value with maximum and minimum thresholds set in advance for the document color determination. Then, whether the document is a monochrome document or a color document is determined on the basis of this comparison result. The result of the color determination of the document by the document color determination unit 130 is transmitted to the post-processor 200, for example, and is used for image processing performed in the post-processor 200.

As described above, the ACS processing by the ACS processor 108 is performed on the basis of the a* and b* signals, which are chroma information, among the L*, a* and b* signals. Specifically, if a document to be read is a monochrome document, the document has no chroma, and thus a* and b* takes values near 0. Meanwhile, if a document to be read is a color document, the document has chroma, and thus a* and b* takes values away from 0. Accordingly, the determination as to whether the read document is a monochrome document or a color document may be performed by setting the above-mentioned maximum and minimum thresholds in the same range including, generally, 0 as a center, for a* and b*.

In practice, however, the average of a* and that of b* may take values away from 0 even for a monochrome image due to a variation in the reading characteristic by aging, a tolerance of the image reading apparatus 1, and the like.

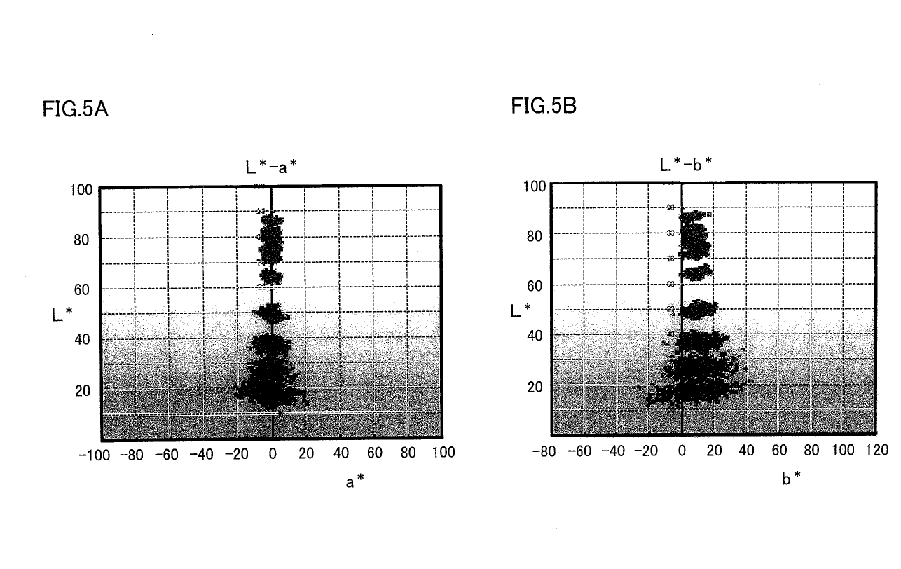

FIGS. 5A and 5B are graphs respectively showing a relationship between an a* value and an L* value and a relationship between a b* value and an L* value on a pixel-by-pixel basis when a monochrome image is actually read by the image reading apparatus 1.

FIG. 5A shows the relationship between an a* value and an L* value with the horizontal and vertical axes indicating a* and L*, respectively, whereas FIG. 5B shows the relationship between a b* value and an L* value with the horizontal and vertical axes indicating b* and L*, respectively. Specifically, change of variation in the chroma information due to lightness change may be obtained from FIGS. 5A and 5B, since L* is lightness information.

In FIG. 5A, it is found that a* takes values near 0 in relation to change of the L* values (lightness change). On the other hand, in FIG. 5B, it is found that b* has averages thereof away from 0 to be displaced to the plus side in relation to change of the L* values (lightness change). Specifically, if the above-mentioned method in which the maximum and minimum thresholds are set in the same range including 0 as a center is used, the actual values of a* and b* are likely to be away from this range. In this case, the ACS processor 108 determines that an image is a color image in error, in spite of being a monochrome image.

Accordingly, in the present exemplary embodiment, the image reading apparatus 1 is provided with the chroma reference plate 56C as described using FIG. 1, and performs the color determination by comparing chroma information of an image of a document sheet with thresholds calculated from chroma information obtained by reading the chroma reference plate 56C.

This point will be further described hereinafter.

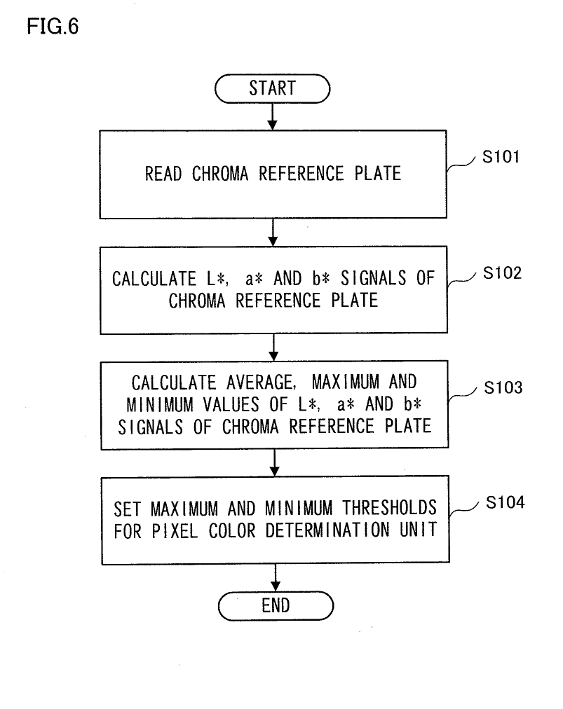

FIG. 6 is a flowchart illustrating a first procedure of the color determination according to the present exemplary embodiment.

The procedure of the color determination described in FIG. 6 is for a case where the number of the chroma reference plate 56C is one.

First, the reading device 50 (see FIG. 1) of the image reading apparatus 1 reads the chroma reference plate 56C placed on the bottom of the guide 56A (see FIG. 1) and having a predetermined chroma (Step 101). The control/image-processing unit 60 then generates L*, a* and b* signals of the chroma reference plate 56C with the procedure as described using FIGS. 2 and 3 (Step 102). Next, the pixel color determination unit 110 (see FIG. 4) of the ACS processor 108 (see FIGS. 3 and 4) calculates the average, maximum and minimum values of the L*, a* and b* signals of the chroma reference plate 56C (Step 103). The pixel color determination unit 110 then determines maximum and minimum thresholds, which are as thresholds in order for the pixel color determination unit 110 to perform the color determination of pixels, for each of a* and b*, on the basis of the average, maximum and minimum values of the L*, a* and b* signals (Step 104). These maximum and minimum thresholds may be set to the same values as the above-mentioned maximum and minimum values of a* and b*. Instead, the maximum thresholds may be set to values a little larger than the above-mentioned maximum values, whereas the minimum thresholds may be set to values a little smaller than the above-mentioned minimum values, from the standpoint of giving an importance to prevent erroneous determination.

By these setting, the thresholds are allowed to be obtained based on the chroma reference plate 56C. Accordingly, the ACS processing is not easily influenced by a variation in the reading characteristic by aging and a tolerance of the image reading apparatus 1, and thereby erroneous determination of the ACS processor 108 does not easily occur.

As is clear from FIGS. 5A and 5B, variations in values of a* and b* tend to become larger as the value of L* becomes smaller, namely, as an obtained image becomes darker. For this reason, erroneous determination of the ACS processor 108 may be likely to occur in a region where an image is dark, with the method in which one type of the chroma reference plate 56C is used and one combination of the thresholds is set as described in FIG. 6. In order to deal with this problem, plural chroma reference plates 56C may be provided, and thresholds may be calculated for each value of lightness of the chroma reference plates 56C by use of chroma information of each chroma reference plate 56C, and thereby the color determination may be performed. By this configuration, erroneous determination of the ACS processor 108 may be further unlikely to occur.

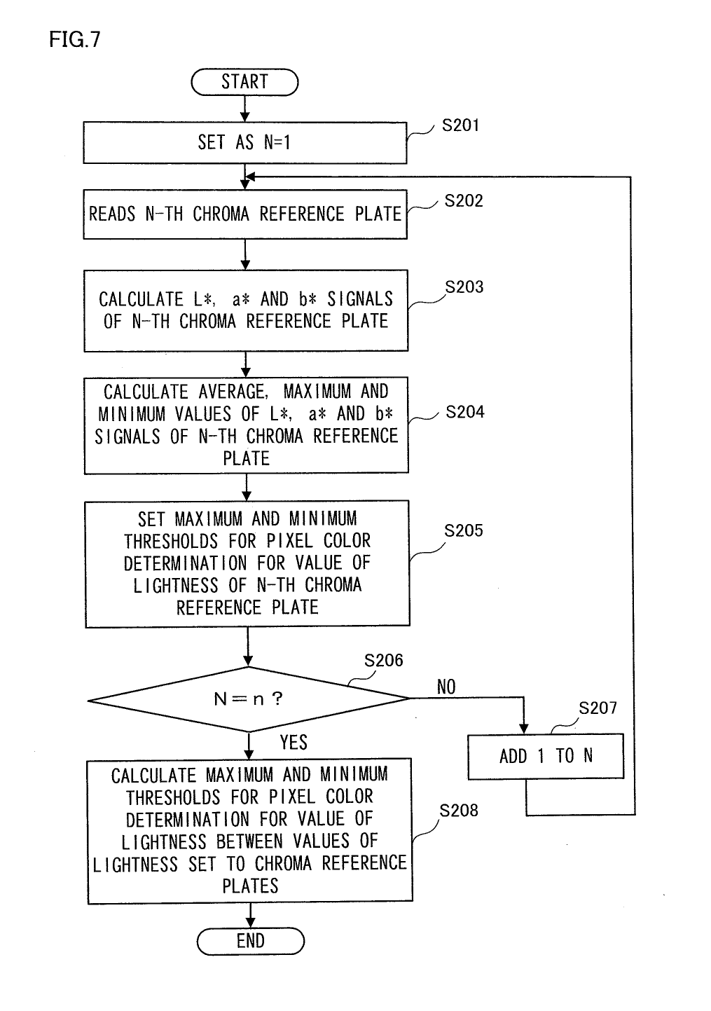

FIG. 7 is a flowchart illustrating a second procedure of the color determination according to the present exemplary embodiment.

The procedure of the color determination described in FIG. 7 is for a case where the number of the chroma reference plates 56C is n.

First, a parameter N is set to 1 (Step 201). The value of this parameter N indicates which chroma reference plate 56C is being read among the n chroma reference plates 56C. Here, N is first set as N=1 to perform setting for reading a first chroma reference plate 56C. Next, the reading device 50 (see FIG. 1) of the image reading apparatus 1 reads the first chroma reference plate 56C placed on the bottom of the guide 56A (see FIG. 1) (Step 202). The control/image-processing unit 60 then generates L*, a* and b* signals of the chroma reference plate 56C with the procedure similar to that described in FIG. 6 (Step 203). The pixel color determination unit 110 (see FIG. 4) of the ACS processor 108 (see FIGS. 3 and 4) calculates the average, maximum and minimum values of the L*, a* and b* signals of the chroma reference plate 56C (Step 204). The pixel color determination unit 110 then determines maximum and minimum thresholds, which are as thresholds in order for the pixel color determination unit 110 to perform the color determination of pixels, for each of a* and b*, on the basis of the average, maximum and minimum values of the L*, a* and b* signals (Step 205). Next, determination as to whether N=n is made (Step 206). Since N=1 in this case, one is added to n (Step 207), and the procedure from Steps 202 to 205 is repeated. Specifically, hereinafter, second to n-th chroma reference plates 56C are sequentially read, and maximum and minimum thresholds, as the thresholds, are determined for each of the chroma reference plates 56C. This repetition continues until all of the n chroma reference plates 56C are read. That is, if N=n at Step 206, the repetition is finished. With this sequential operation, the thresholds may be obtained based on the plural chroma reference plates 56C having different values of lightness, and the maximum and minimum thresholds for the pixel color determination may be obtained for each value of lightness. Accordingly, erroneous determination of the ACS processor 108 may be more unlikely to occur by performing the color determination with these maximum and minimum thresholds.

Additionally, processing to calculate maximum and minimum thresholds for the pixel color determination with regard to a value of lightness between the values of lightness set to the chroma reference plates 56C may be performed (Step 208). That is, the maximum and minimum thresholds may be calculated by interpolation even for a value of lightness that is not set to the chroma reference plates 56C. Accordingly, erroneous determination of the ACS processor 108 may be much more unlikely to occur by performing the color determination with these maximum and minimum thresholds.

Additionally, the image reading apparatus 1 of the present exemplary embodiment is regarded as an image processor including a color determination unit that performs color determination as to whether an image of a read document sheet is a color image or a monochrome image, wherein the color determination unit performs the color determination by comparing chroma information of the image of the document sheet with thresholds with regard to chroma that are set for different values of lightness, the chroma information corresponding to each of the values of lightness.

Note that the processing described in FIGS. 6 and 7 may be performed when the power supply of the image reading apparatus 1 is turned on, for example.

Additionally, what has been described above may be used for so-called calibration of the image reading apparatus 1.

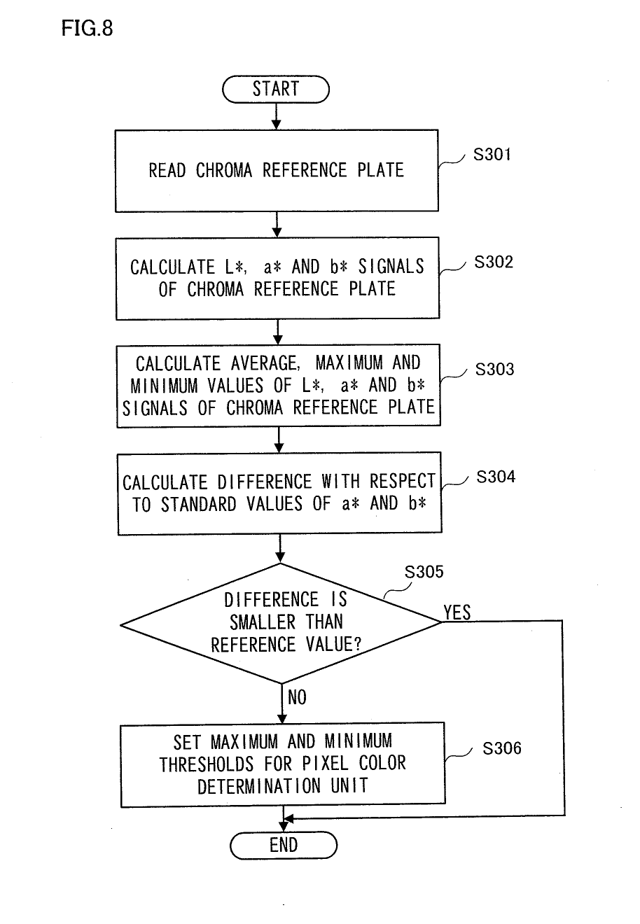

FIG. 8 is a flowchart illustrating a third procedure of the color determination according to the present exemplary embodiment.

The procedure of the color determination described in FIG. 8 is for a case where the number of the chroma reference plate 56C is one.

First, operations in Steps 301 to 303 are similar to those in Steps 101 to 103 described in FIG. 6. Next, in the present exemplary embodiment, a difference between calculated values of a* and b* of the chroma reference plate 56C and standard values of a* and b* prepared in advance (Step 304). Values of a* and b* when the image reading apparatus 1 has been manufactured or those at a time point preceding a predetermined period may be set as the standard values of a* and b* prepared in advance. If the difference is smaller than a reference value (Yes in Step 305), the processing is finished. Meanwhile, if the difference exceeds the reference value (No in Step 305), maximum and minimum thresholds, which are the thresholds for the pixel color determination unit 110 are set (Step 306). By performing such an operation, the maximum and minimum thresholds are allowed to be set again when the difference exceeds the reference value set in advance. That is, an operation of calibration may be performed.

Although a description has been given in FIG. 8 by taking a case where one chroma reference plate 56C is used as an example, plural chroma reference plates 56C as described in FIG. 7 may be used.

In the above-described examples, the chroma reference plate 56C is provided, and chroma information is acquired by reading the chroma reference plate 56C. However, the present invention is not limited to this configuration. Specifically, chroma information may be acquired by reading an image of a document sheet or the like having a predetermined chroma, for example, without providing the chroma reference plate 56C. Similar function may be realized even with this method.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image reading apparatus comprising:
a light source that irradiates a document sheet with light;
a light receiving unit that receives reflected light from the document sheet; and
a color determination unit that performs color determination as to whether an image of the document sheet is a monochrome image or a color image by comparing chroma information of the image of the document sheet read by the light receiving unit with a threshold calculated from chroma information obtained by reading an image having a predetermined chroma.

2. The image reading apparatus according to claim 1, further comprising a chroma reference member that has a predetermined chroma, wherein
the image having the predetermined chroma is acquired by reading the chroma reference member.

3. The image reading apparatus according to claim 1, wherein the color determination unit calculates a maximum threshold and a minimum threshold from the chroma information obtained by reading the image having the predetermined chroma, and compares the maximum threshold and the minimum threshold with chroma information, corresponding to lightness of the image having the predetermined chroma, of the image of the document sheet, to perform the color determination.

4. The image reading apparatus according to claim 1, wherein the color determination unit performs the color determination by using an a* value and a b* value in an L*a*b* colorimetric system as the chroma information.

5. The image reading apparatus according to claim 1, wherein a plurality of the images having the predetermined chroma are acquired, and the plurality of images have values of lightness different from each other.

6. The image reading apparatus according to claim 5, wherein the color determination unit uses the chroma information of each of the plurality of images having the predetermined chroma and having the values of lightness different from each other, and calculates a plurality of thresholds for each of the values of lightness to perform the color determination.

7. The image reading apparatus according to claim 6, wherein the color determination unit further calculates, from the thresholds calculated for each of the values of lightness, a threshold of a value of lightness that the plurality of images having the predetermined chroma do not have, and uses the calculated threshold as well as the thresholds calculated for each of the values of lightness, to perform the color determination.

8. The image reading apparatus according to claim 1, wherein the color determination unit updates the threshold if the chroma information obtained by reading the image having the predetermined chroma exceeds a reference value.

9. An image processor comprising:
a color determination unit that performs color determination as to whether the image of the document sheet read by a reading unit, which reads an image of a document sheet, is a monochrome image or a color image, by comparing chroma information of the image of the document sheet with thresholds with regard to chroma that are set for different values of lightness, the chroma information corresponding to each of the values of lightness.

10. A color determination method for an image reading apparatus that includes a light source irradiating a document sheet with light, and a light receiving unit receiving reflected light from the document sheet, the method comprising:
making a comparison between chroma information of an image of the document sheet read by the light receiving unit and a threshold calculated from chroma information obtained by reading an image having a predetermined chroma; and
determining whether the image of the document sheet is a monochrome image or a color image, on the basis of a result of the comparison.
